(19) United States
(12) Patent Application Publication
(10) Pub. No.: US 2025/0303396 A1
(43) Pub. Date: Oct. 2, 2025

(54) COMPOSITIONS FOR AND METHOD OF MAKING METHANE ABATEMENT CATALYSTS

(71) Applicant: CDTi Advanced Materials, Inc., Oxnard, CA (US)

(72) Inventors: Edward J. Lee, Ventura, CA (US); Jason C. Michl, Oxnard, CA (US); Juan Nunez, Oxnard, CA (US); Blake Hermann, Oxnard, CA (US); Ru-Fen Liu, Ventura, CA (US); Campbell McConnell, San Francisco, CA (US)

(21) Appl. No.: 19/095,802

(22) Filed: Mar. 31, 2025

Related U.S. Application Data
(60) Provisional application No. 63/572,817, filed on Apr. 1, 2024.

(51) Int. Cl. B01J 23/44; B01D 53/86; B01J 21/06; B01J 23/10; B01J 35/00; B01J 37/02; B01J 37/08

(52) U.S. Cl. CPC B01J 23/44; B01D 53/864; B01J 21/066; B01J 23/10; B01J 35/19; B01J 37/0244; B01J 37/08; B01D 2255/1021; B01D 2255/1023; B01D 2255/2063; B01D 2255/2065; B01D 2255/2066; B01D 2255/2068; B01D 2255/9022; B01D 2255/908; B01D 2257/7025; B01D 2258/018

(57) ABSTRACT

Methane oxidation catalysts are disclosed to efficiently convert methane emissions with the lean air-methane ratio between 20:1 to 65:1 into less harmful byproducts such as carbon dioxide and water. This novel catalyst utilizes an engineered combination of precious metal group particles supported on the transition metal oxide particles on a high-surface-area substrate. Its catalytic mechanism involves 1) the activation of methane molecules on the catalyst surface, followed by their oxidation into CO₂ and H₂O through a series of intermediate steps, 2) by the additional methane adsorption sites from cheaper base-metal catalyst and abate it via reformation process, 3) by allowing gas phase oxygen adsorption competing between precious group metal catalyst and base-metal oxide catalyst surfaces to facilitate oxygen diffusion for oxidation process, and 4) by preventing water occupying active precious metal sites by promoting the adjacent preferential water adsorption sites formed by the oxides with lower enthalpy of formation of hydroxides.

### RELATED APPLICATIONS

This application claims priority under 35 U.S.C. § 119 (e) of the co-pending U.S. provisional patent application Ser. No. 63/572,817, filed Apr. 1, 2024, and titled “COMPOSITIONS FOR METHANE ABATEMENT CATALYST AND METHOD OF MAKING IT”, which is hereby incorporated by reference.

### FIELD OF THE INVENTION

The present invention relates to the field of methane abatement catalyst. More specifically, the present invention relates to methane oxidation catalyst for removing the greenhouse gas methane emission from the lean air-methane combustion engine exhaust.

### BACKGROUND OF THE INVENTION

Methane removal, or methane mitigation, is a critical aspect of greenhouse gas management aimed at reducing methane emissions into the atmosphere. Methane is a potent greenhouse gas with a 85 times higher global warming potential than carbon dioxide over 20 years timescales. Effective methane removal strategies are essential for mitigating climate change and achieving global emission reduction targets. Catalysts can be employed to facilitate the oxidation of methane into less harmful byproducts such as carbon dioxide and water. These catalysts can be integrated into industrial processes, combustion systems, and emission control technologies to convert methane emissions before they are released into the atmosphere. Conventional precious group metal (PGM) emission catalysts are widely used in various industrial applications and emission control systems to reduce harmful emissions, including those of volatile organic compounds (VOCs), nitrogen oxides (NOx), and carbon monoxide (CO), among others.

### SUMMARY OF THE INVENTION

It is well-known palladium catalyst exhibits superior activity toward methane (CH₄) activation. PdO (palladium oxide) is the active phase of the catalyst. While palladium methane oxidation catalysts offer excellent performance in activity and selectivity, the industries suffer its high cost, sensitivity to poisoning by water to form the inactive palladium hydroxide surface, sulfation and other chemicals, limited thermal durability due to sintering effect losing catalyst surface area, and PdO decomposition to Pd metal above 800° C., therefore the improvement of such catalyst remains essential for their widespread deployment and commercial viability.

It is challenging from the application perspective. The air-methane ratio, which refers to the ratio of oxygen to methane in the feed gas stream, can influence the performance of methane oxidation catalysts. At excessively high air-methane ratios, catalyst efficiency may be compromised due to oxygen limitation or incomplete mixing of reactants. Methane oxidation catalysts may exhibit transient responses or performance variations under dynamic operating conditions, such as changes in temperature, flow rate, or gas composition. Enabling tailoring the catalyst's kinetics and response dynamics by its structure and compositions is crucial for predicting and managing performance under transient operating conditions. In this disclosure, a composite catalyst structure is provided to tackle these challenges under the excess air-methane ratio above 17:1.

In addition to carefully considering the air-methane ratio for methane emission control, the compressed natural gas, depending on the source, might contain small amounts of sulfur dioxide impurities, typically less than 1 ppm. In the other instance, natural gas (NG) engine application can involve the use of a small amount of diesel fuel injected into the combustion chamber to initiate ignition of the compressed natural gas-air mixture. This approach, known as diesel pilot ignition or dual-fuel combustion, is commonly employed in dual-fuel engines to improve combustion stability, extend the lean-burn limit, and enhance overall engine performance. Hence, the source of natural gas and the pilot diesel fuel can contribute to the source of sulfur in the combustion exhaust, while palladium catalyst is known to be chemically poisoned through sulfation. In some applications, the pilot diesel fuel is the major sulfur source from such as very-low sulfur fuel oil containing the maximum 0.5% of sulfur from which the amount of sulfur dioxide generated after combustion could affect the performance of a palladium-based catalyst in the downstream after-treatment system. Therefore, addressing sulfur durability of catalytic methane abatement technologies is crucial for a real-world application.

The disclosure is an advanced methane oxidation catalyst designed to efficiently convert methane emissions with the lean air-methane ratio above 17:1 into less harmful byproducts such as carbon dioxide and water. This novel catalyst utilizes a carefully engineered combination of precious metal group particles supported on the transition metal oxide particles on a high-surface-area monolith substrate. In some embodiments, the catalytic mechanism involves 1) the activation of methane molecules on the catalyst surface, followed by their oxidation into CO₂ and H₂O through a series of intermediate steps, 2) by the additional methane adsorption sites from cheaper base-metal catalyst and abate it via reformation process, 3) by allowing gas phase oxygen adsorption competing between precious group metal catalyst and base-metal oxide catalyst surfaces to facilitate oxygen diffusion for oxidation process and) by preventing water occupying active precious metal sites by promoting the adjacent preferential water adsorption sites formed by the oxides with lower enthalpy of formation of hydroxides. The catalyst's design and synthesis optimize catalytic activity, selectivity, and durability, making it suitable for various applications including but not limited to the stationary compressed natural gas engine in industrial emissions control, dual-fuel power generator on ships. Overall, this methane abatement catalyst represents a breakthrough in methane abatement technology, offering a sustainable solution for mitigating methane emissions and combating climate change.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a composite catalytic Structure A in accordance with some embodiments.

FIG. 2 illustrates another composite catalytic structure B in accordance with some embodiments.

FIG. 3 illustrates an embodiment of a fresh catalyst performance in accordance with some embodiments.

FIG. 4 illustrates the catalytic aging performance of Structure A in accordance with some embodiments.

FIG. 5 illustrates the catalytic aging performance of the conventional Pd catalyst in Structure A₀ in accordance with some embodiments.

FIG. 6 illustrates the catalytic aging performance among selected Structure A catalysts in Structure A₀ in accordance with some embodiments.

FIG. 7 illustrates the examination of the 700° C. hydrothermally aged catalysts under SEM and EDS analysis in accordance with some embodiments.

FIG. 8 illustrates the improved catalyst examples of Structure A with CoOx—FeOx and NiOx—FeOx as the base-metal oxide additives in accordance with some embodiments.

FIG. 9 illustrates the sulfur poisoning effect and the regeneration of methane abatement activity of Structure A with BMOx═NiOx and FeOx in accordance with some embodiments.

FIG. 10 illustrates ZrOx—FeOx solid solution phases in accordance with some embodiments.

FIG. 11 illustrates methane oxidation mechanisms in accordance with some embodiments.

FIG. 12 illustrates more methane oxidation mechanisms in accordance with some embodiments.

FIGS. 13-23 illustrate more composite catalytic structures in accordance with some embodiments.

FIG. 24 illustrates a method of making a methane reactive catalyst in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business-related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

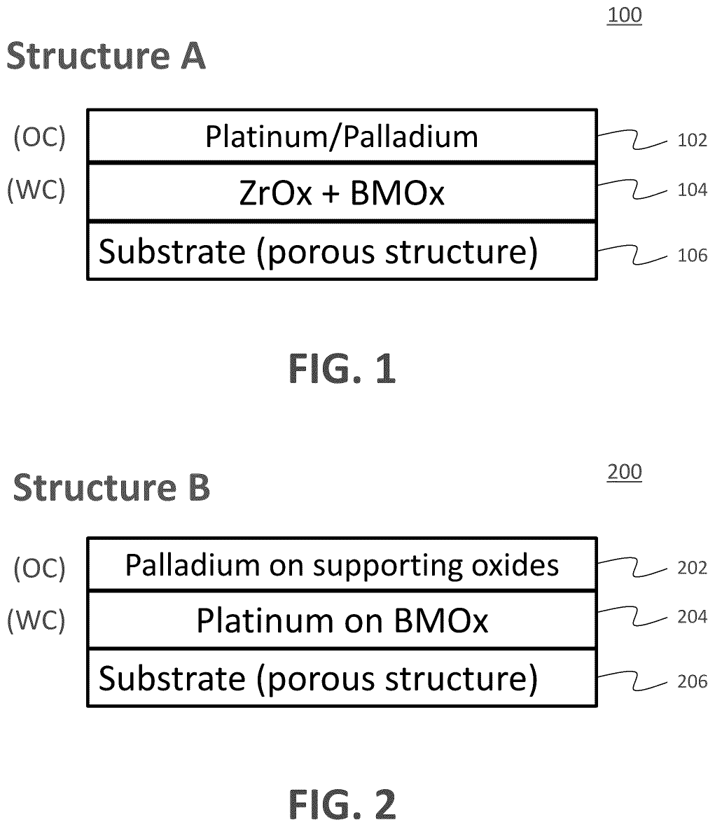

FIGS. 1 and 2 illustrate composite catalytic Structure A & B in accordance with some embodiments.

In some embodiments, the Structure A 100 comprises a substrate 106, a washcoat 104, and a metal layer 102. The substrate 106 is able to be a porous structure. The washcoat 104 (e.g., the 1^{st} layer on the substrate 106) is able to be Zirconia (pure or Ce, Pr, Nd-doped) mixture with base metal oxides (BMOx), where BMOx═FeOx, NiOx, CoOx, alumina (doped or undoped), Fe—NiOx, Fe-CoOx, Ni-CoOx, or Fe—Ni—CoOx. The metal layer 102 (e.g., the 2^{nd} layer on washcoated substrate) is able to be a Pt/Pd, where Pt:Pd ratio is from 1:1 to 1:39, preferably 1:19 by impregnation or overcoat with ZrOx-based support oxide.

In some embodiments, the Structure B 200 comprises a substrate 206, a washcoat 204, and an overcoat 206. The substrate 206 is able to be a porous structure. The washcoat 204 (e.g., the 1^{st} layer on the substrate 206) contains Platinum on BMOx, wherein the BMOx═FeOx, NiOx, CoOx, Alumina (doped or undoped), Fe—NiOx, Fe—CoOx, Ni—CoOx, or Fe—Ni—CoOx. The overcoat 206 (e.g., the 2^{nd} layer on washcoated substrate) is able to be Pt/Pd in oxide form adsorbed on OSM (oxygen storage materials), wherein supporting oxides=porous Zirconia (pure or Ce, Pr, Nd-doped), Ceria, Alumina (doped or undoped), or combined. The Pt:Pd ratio is from 1:1 to 1:39, preferably 1:19.

In some embodiments, the process of making the Structures A & B involves forming a slurry by mixing metal oxide supports with aluminum hydroxides or hydroxyethyl cellulose, which act as binders, and deionized water as the solvent medium. Following the formation of this slurry, the process may include an optional pH adjustment step. This adjustment can be achieved by introducing either organic acids (such as acetic acid) or bases (like ammonium hydroxide) to modify the system's pH as required. This approach allows for precise control over the material's properties and ensures optimal performance of the resulting structure.

The mixture undergoes a milling processing to produce a slurry system adhering onto the selected porous substrates, specifically by controlling the targeted d50 particle size and viscosity of the slurry. Here, d50 is used as the control parameter of the slurry, and it is usually measured in μm. The optimized d50 of the slurry depends on the characteristic of porous substrates, where the particles in the slurry as a whole able to hold onto the porous substrate surfaces. Once the slurry is obtained, the method of applying slurries onto a porous monolith is completed by creating shear stress to allow the materials adsorbing and adhering to the porous substrates with targeted loadings. The mixture of Precious Metal Group precursors, such as but not limited to Platinum nitrate and Palladium nitrate, used in Structure A, is created stoichiometrically and applied on the washcoated substrate by the similar manner as applying a slurry on the monolith. Once the catalyst materials are fully coated onto substrates, a heat treatment process is utilized to create the required active catalytic oxide phases and structures on the substrates. The heat treatment involves drying the catalyst-coated monolith substrate in an oven at 150° C. for at least 2 hours and followed by a temperature ramping of 3° C./min rate to a higher temperature treatment at least at 550° C., preferably at 600° C. but below 800° C. in air, for at least 4 hours.

The phase of Zirconia, tetragonal phase and monoclinic phase are important in the application of methane oxidation catalyst and provides preferable impact of tetragonal phase for such application, which is further evidenced by U.S. Pat. No. 10,112,178 which is incorporated by reference for all purposes. The tetragonal phase of Zirconia is able to be generated at extreme high temperature above 1200° C., or a pressure-driven phase transition above 7 GPa at a rather lower temperature 750° C. The highly stable structure of tetragonal phase of Zirconia makes it a good support oxide for catalyst. In addition, it can form a solid solution with Cerium oxide, which is common automotive catalyst for removing CO and Hydrocarbons, making it attractive for methane applications.

Here, the Zirconia support comprising at least 90% tetragonal phase is used where its tetragonal structure remains stable with less than 10% of rare-earth dopants, such as Lanthanum (La), Cerium (Ce), Praseodymium (Pr) and Neodymium (Nd). In addition to the dopants and its tetragonal phase, the Zirconia support is characterized by the fresh surface area between 50 m²/g and 90 m²/g and the measured total pore volume reached 0.31 cm³/g with an average pore size of about 18 nm. Furthermore, the tetragonal phase of Zirconia remains stable when incorporating with base-metal such as Iron (Fe) (See FIG. 21). 15% wt of Ceria and iron oxides can incorporate with the tetragonal Zirconia described above.

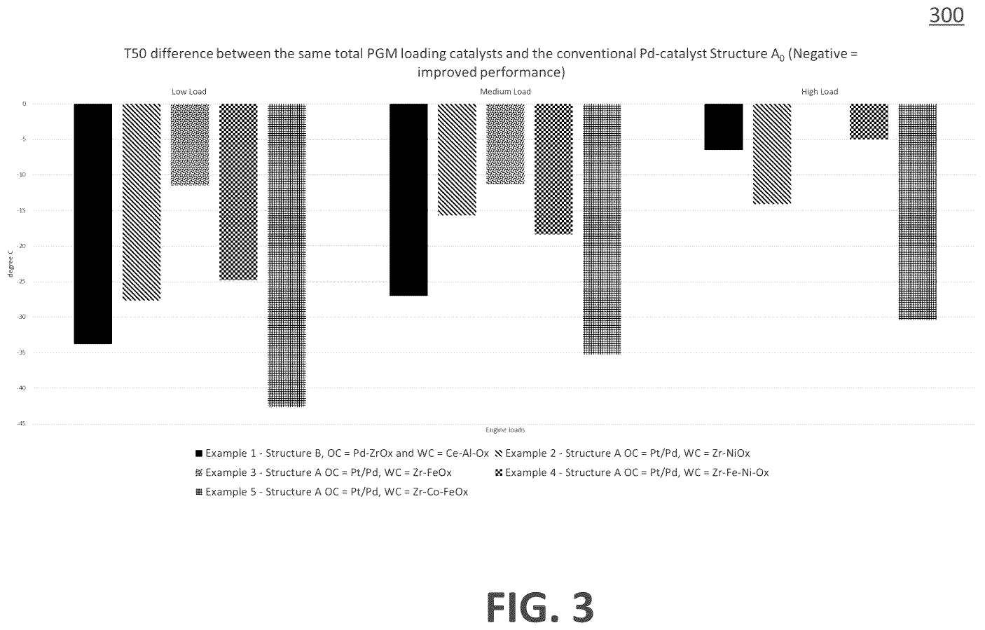

FIG. 3 illustrates an embodiment 300 of a fresh catalyst performance over the conventional Pd catalyst under different engine load exhausts. Temperature differences of Methane conversion at 50% (ΔT50=T50_{Structure A, B}−T50_{Structure A0}) between the catalysts described in Structure A or B and the conventional Zirconia supported Palladium methane oxidation catalyst, as in Structure A without BMOx, hereafter assigned as Structure A₀, are calculated and plotted in this figure, where T50 is the temperatures of 50% methane conversion achieved. Negative values indicate more active of the proposed Structures A and B, than the conventional Pd/ZrO₂ catalyst Structure A₀. The results show that both Structures A and B improve the CH₄ abatement performance over the conventional methane catalyst Pd/ZrO₂ Structure A₀. It is also observed that Structure A and B are more superior abatement catalyst than conventional methane catalyst as the % of methane conversion increases.

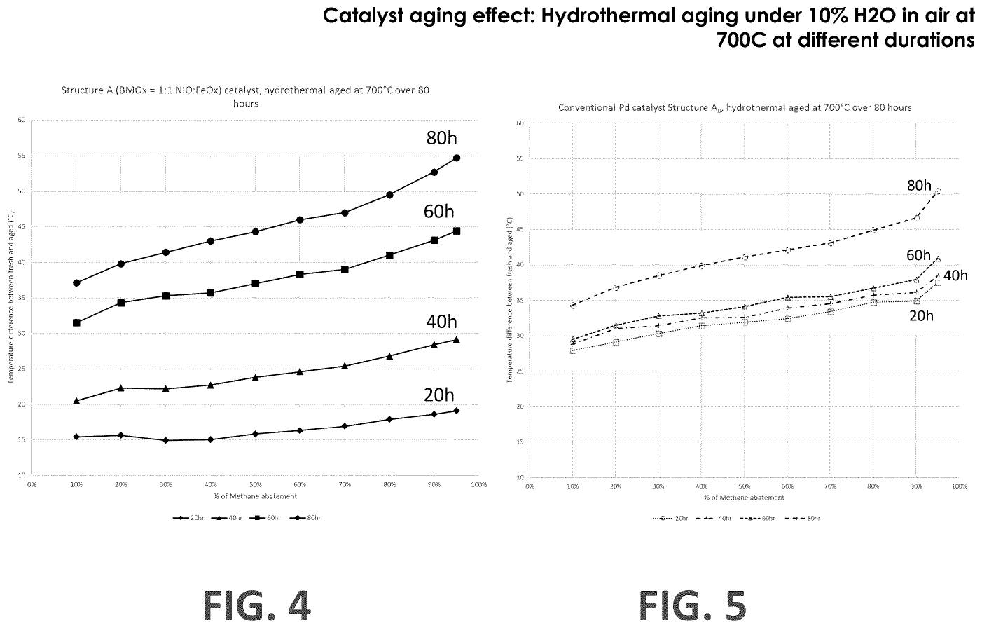

FIG. 4 illustrates the catalytic aging performance of Structure A (BMOx═NiO:FeOx 1:1) undergone hydrothermal aging at 700° C. for 20 hours, 40 hours, 60 hours, and 80 hours in accordance with some embodiments.

It is shown that Structure A ages gradually, e.g. at the 50% of methane conversion, the catalyst degrades only about 15° C. after 20 aging hours, about 24° C. after 40 aging hours, 37° C. after 60 aging hours, and 44° C. after 80 aging hours.

FIG. 5 illustrates the catalytic aging performance of the conventional Pd catalyst in Structure A₀ undergone hydrothermal aging at 700° C. for 20 hours, 40 hours, 60 hours, and 80 hours in accordance with some embodiments.

It is shown that the conventional Pd catalyst Structure A₀ ages quickly in just 20 hours of hydrothermal aging, e.g. at the 50% of methane conversion, the catalyst degrades severely, about 35° C. after 20 aging hours, and the performance stays similar until another 6-10° C. degradation after 80 aging hours.

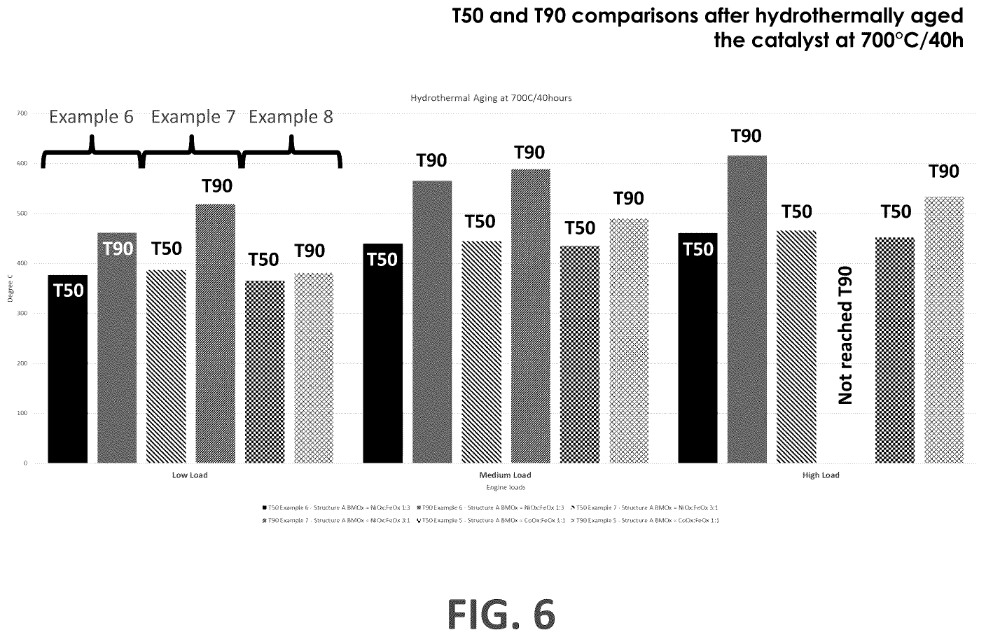

FIG. 6 illustrates the catalytic aging performance among selected Structure A catalysts (Example 5, 6 and 7) based on T50 and T90 (T90 is the temperature where the methane conversion achieves at 90%). It is shown that CoOx and FeOx is able to excel its hydrothermal aging performance than NiOx and FeOx as base-metal additives, showing CoOx—FeOx based additives suitable for lower temperature applications.

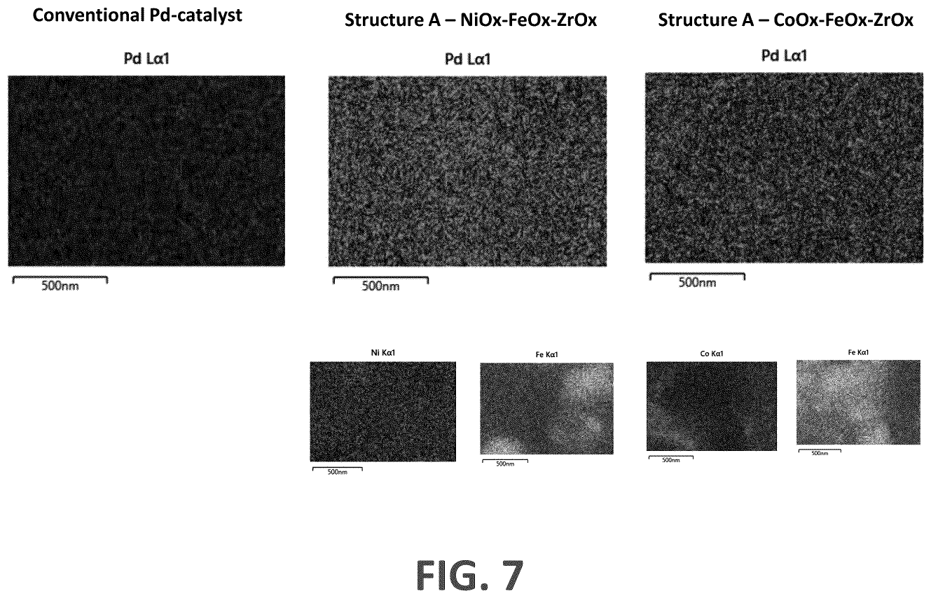

FIG. 7 examined the 700° C. hydrothermally aged catalysts under SEM and EDS analysis in accordance with some embodiments. The metal particle distributions are shown separately for conventional Pd-catalyst, the Structure A with NiOx—FeOx—ZrOx support oxides, and the Structure A with CoOx—FeOx—ZrOx supports. The distribution of surface palladium particles remains relatively uniform across all three aged catalysts under investigation. In the sample of Structure A with NiOx—FeOx additives, nickel additives maintain an even distribution following hydrothermal aging, while iron particles exhibit segregation. Conversely, in the sample of Structure A with CoOx—FeOx additives, both cobalt and iron particles demonstrate mutual segregation. This segregation of base-metal oxides results in the formation of distinct surface domains, which more effectively inhibit the sintering of palladium particles. Consequently, this phenomenon helps preserve methane conversion activity in the catalyst even after the aging process.

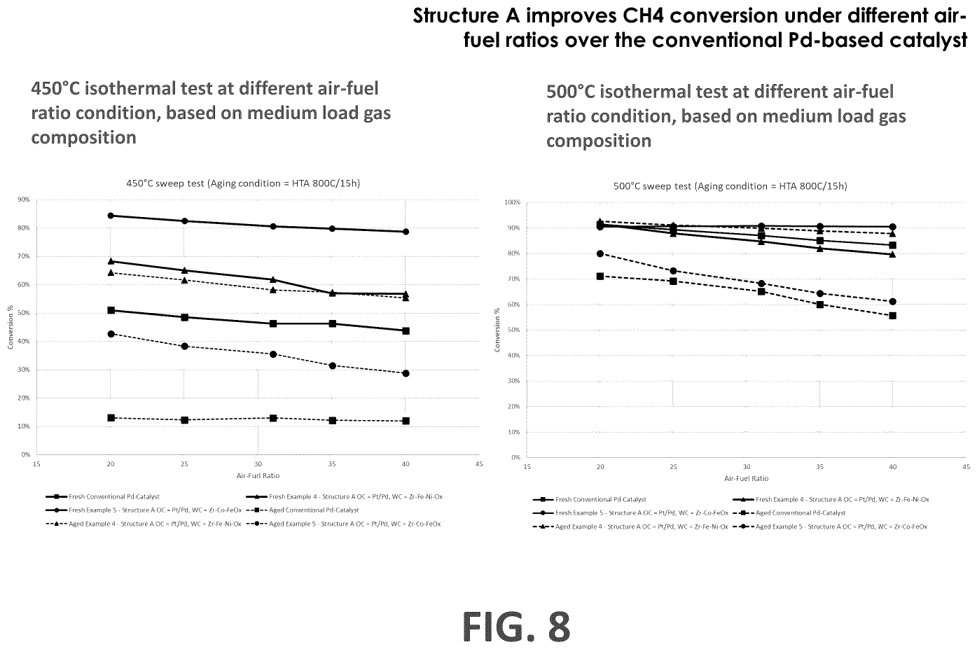

FIG. 8 illustrates the improved catalyst examples of Structure A with CoOx—FeOx and NiOx—FeOx as the base-metal oxide additives in accordance with some embodiments.

In order to address the catalyst performance under various air-fuel ratios, FIG. 8 illustrates the improved catalyst examples of Structure A with CoOx—FeOx and NiOx—FeOx as the base-metal oxide additives, compared with the conventional Pd-based catalyst, for both fresh catalyst (solid lines) and hydrothermal aged at 800° C. for 15h (dashed). Under higher aging temperature, NiOx—FeOx base-metal oxides are more stable additives than CoOx—FeOx based catalyst system.

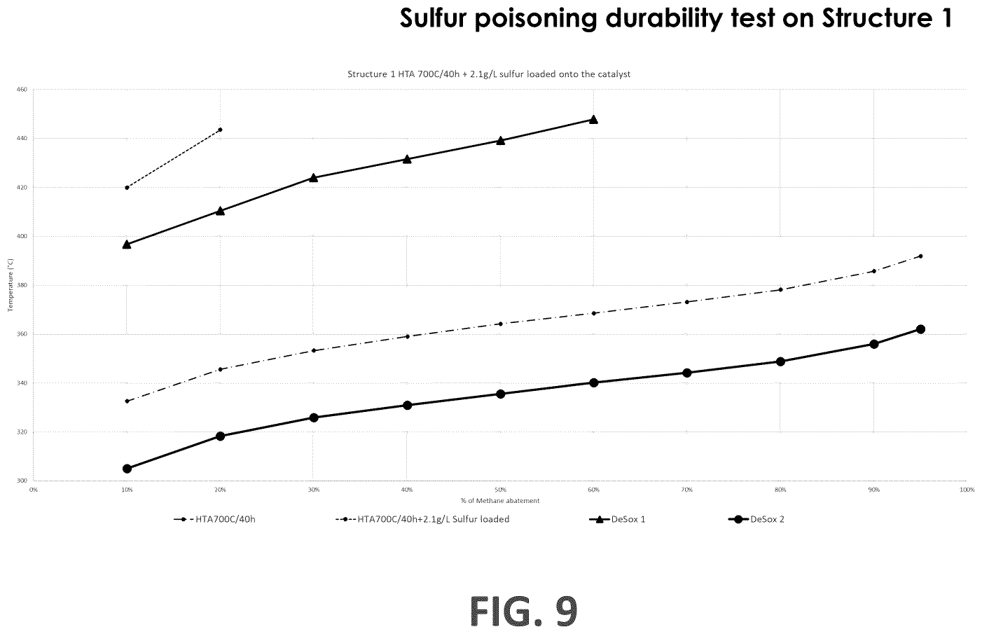

FIG. 9 illustrates the sulfur poisoning effect and the regeneration of methane abatement activity of Structure A with BMOx═NiOx and FeOx in accordance with some embodiments.

It is shown that after 2.1 g/L of Sulfur loaded on the 40 hours aging sample, the catalyst activity is severely impacted (dashed line-sulfur aged, dash-dot line 40 h aged Structure 1 sample). The catalyst activity is slightly recovered after de-sulfation (DeSox) cycle in air (solid line with triangle marks). It is fully regenerated and even recovered better than the aging state, after rich DeSox cycle under 1% CH₄, 0.5% O₂, and 2% H₂O (solid line round marks).

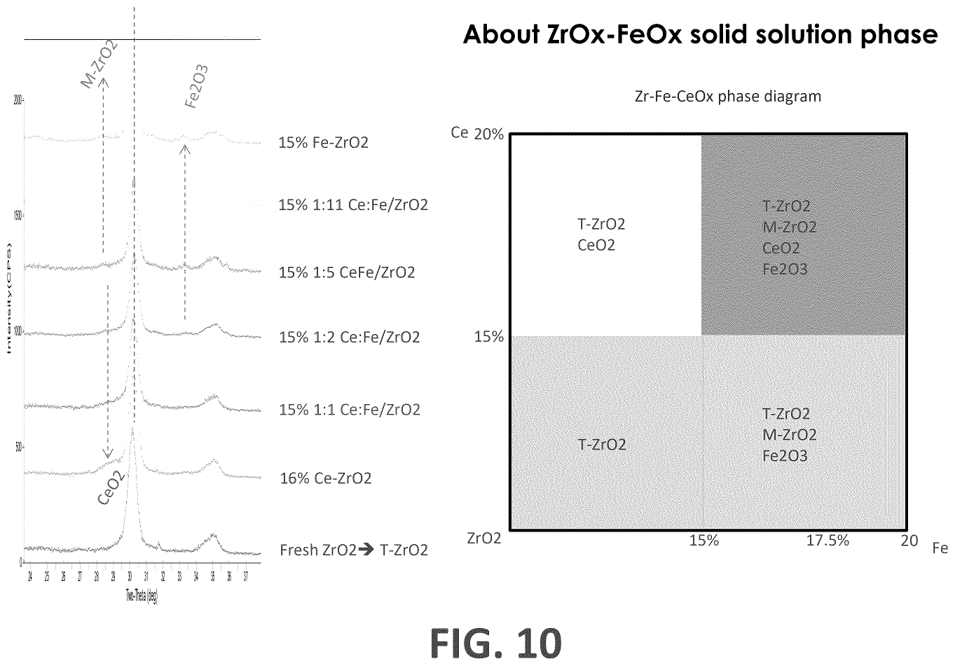

FIG. 10 illustrates ZrOx—FeOx solid solution phases in accordance with some embodiments.

When incorporating metal oxides such as Iron Oxides, Nickel Oxides and Cobalt oxides and Ceria with Zirconia supports, the oxides in the catalyst layer can be obtained by treating metal salts chemically or by heat. The examples of metal salts include iron nitrate, nickel nitrate, cobalt nitrate, cerium nitrate or their counterparts in acetate salts, ammonium nitrate salts oxalate hydrate salts. Addition to using salt precursor of metal oxides, in this work, the pre-formed oxide materials are utilized to incorporate with Zirconia support. Examples of pre-formed oxide materials include Iron oxide in Wustite (FeO), Hematite (Fe₂O₃) or Spinel (Fe₃O₄) structures, Iron hydroxide (Fe⁺², Fe⁺³), NiO in Rocket salt structure, Ni₂O₃, NiO₂ or Nickel hydroxide, CoO, Co₃O₄ Spinel, cobalt hydroxide mixtures, Ceria (CeO₂, Ce₂O₃), Cerium hydroxide and Aluminum Cerium trioxides (AlCeO₃). Under unusual conditions, metal alloy nanoparticles are able to be used as metal precursors to form oxide under heat treatment. Examples of metal alloys nanoparticles are FeNi, NiCo, NiFeCo, FeCo nanoparticles.

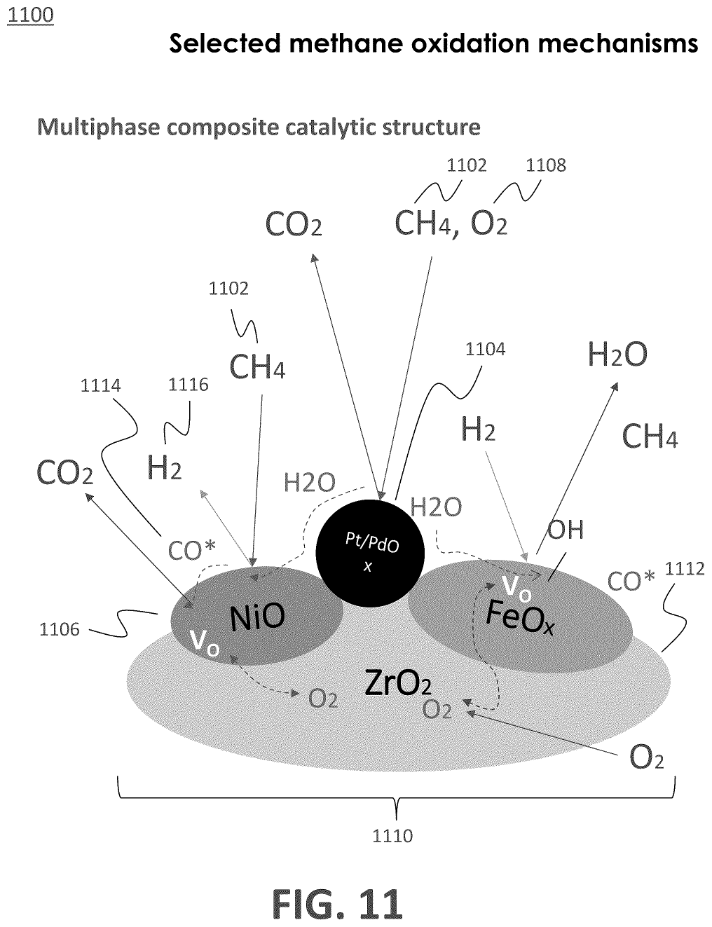

FIG. 11 illustrates methane oxidation mechanisms 1100 in accordance with some embodiments. There can be four aspects of the mechanisms including methane, gas phase oxygen, water/steam and CO and hydrogen by-products.

In terms of methane 1102, methane adsorption occurs efficiently on Pt/PdOx 1104. The additional adsorption pathway on NiO 1106 when there is sufficient thermal energy allows C—H bond activation and breaking on Pd/PdO 1104 sites. In some embodiments, C—H bond activation and breaking on the hetero-adsorption sites at the Pd/PdO/FeOx interface. C—H bond activation and breaking on PdO—ZrO—FeOx facilitated sites.

In terms of gas phase oxygen 1108, O₂ dissociative adsorption efficiently on Pt/PdOx 1104 surfaces. The small amount of Pt (Pd:Pt ratio=19:1 in most of the examples shown here) would likely form a “co-shell” structure together with PdO particles on the surface. The total positive metal valence may change, therefore we symbolized it as Pt/PdOx. The active phase of Palladium catalyst is PdO, where Pd is in +2 state.

Additional O₂ dissociative adsorption pathway on NiO-FeOx and ZrOx—FeOx when the sufficient thermal energy allows O₂ efficiently adsorption and reacts with NiO—FeOx—ZrO₂ 1110 when oxygen vacancies available. Gas phase adsorption in ZrOx 1112 lattice is mobile.

In terms of water/steam, gas phase water is the oxidant for reforming methane, producing CO and H₂ locally on the NiO/ZrO₂ or NiO—FeOx surface. Water is able to be formed after methane oxidized on the Pt/PdOx surface. The water molecule drifts to adjacent FeOx or NiO surface (noted standard heat of formation of the hydroxide for Fe(OH)₂ [-479 KJ/mole], Fe(OH)₃, and Ni(OH)₂ [−529.7 KJ/mole] is much lower than Pd (OH)₂ [−127 KJ/mole]), to prevent reacting with PdO to form surface hydroxide on Pd which deactivate methane oxidation.

In terms of CO 1114 and hydrogen by-products 1116, CO and hydrogen can be produced through partial CH₄ oxidation and steam reforming, which are facilitated through multiphase catalytic structure. CO and hydrogen take up oxygen from the solid catalyst and create oxygen vacancies in the support oxides in the NiO—FeOx—ZrOx multiphase structure. CO and water produced from partial oxidation is able to react via water-gas-shift process to form CO₂ and H₂

Since excessive gas phase oxygen adsorption on the catalyst surface will block the adsorption sites available for methane adsorption, oxygen vacancies mitigate gas phase oxygen concentration locally to produce favorable conditions, e.g., open up more adsorption site for CH₄ adsorption.

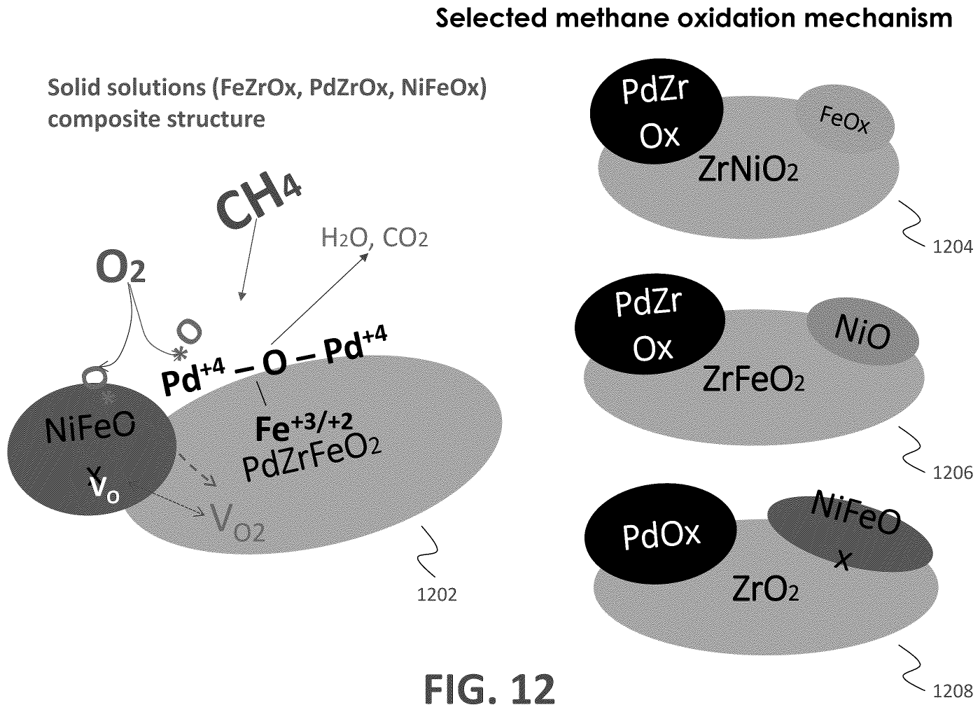

FIG. 12 illustrates more methane oxidation mechanisms in accordance with some embodiments. In some embodiments, solid solutions (FeZrOx, PdZrOx, NiFeOx) composite structure are provided. Structure 1202 illustrates methane oxidation reactions described in FIG. 11 above. Iron-Oxygen, and Nickel-Oxygen bonds in the solid solution phases (FeZrOx 1204, NiFeOx 1206, NiZrOx 1208) changes the characteristic of Pd-Oxygen bond in a pure bulk ZrO₂ or PdO phase, therefore the Pd-Carbon bonding energy is adjusted to a favorable condition for C—H bond activation.

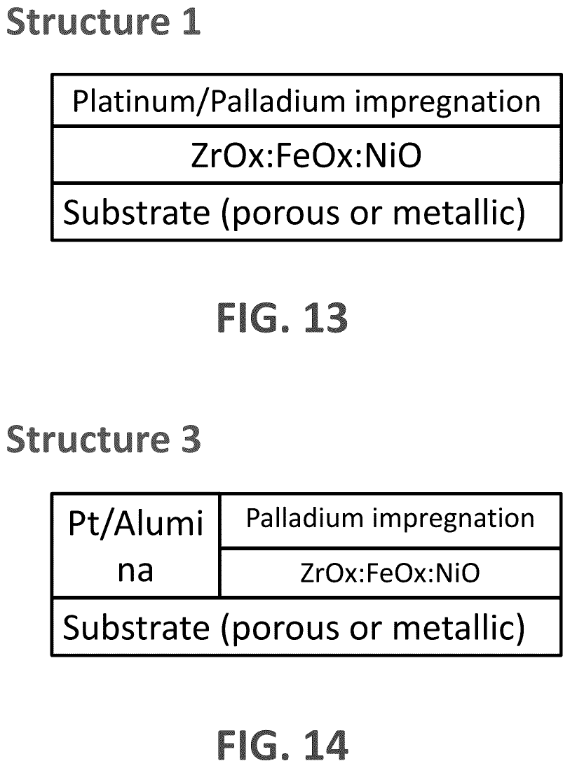

FIGS. 13-23 illustrate more composite catalytic structures in accordance with some embodiments.

FIG. 13 illustrates the Structure 1 as an example of catalyst making in accordance with some embodiments. Catalyst coating refers to the application of catalytic materials onto a substrate surface to facilitate chemical reactions. This process involves depositing a thin layer or coating of catalytic material, e.g., washcoat, onto a support material, such as ceramic or metallic substrates, to create a catalytically active surface.

The catalytic materials are first prepared in slurry form. Washcoat slurry is made of mixing deionized water with doped Zirconium oxide, iron oxide, nickel oxide powders and binder together, where doped Zirconia particles contains more than 50% of catalyst material loading by mass, while the combination of nickel oxide and iron oxide is less than 50% of total catalyst material loading by mass, preferably in the ratio of 50:20:20:10 by mass with doped zirconia, nickel oxide, iron oxide and alumina binder respectively.

The amount of deionized water is designed to achieve the solid percentage of 20%-50% in the slurry. The slurry mixture undergoes a milling process, to harmonize the slurry so that the 50% of particle size, e.g., D50, measured by the particle size analyzer, reaches the targeted diameter in microns. In this process, the viscosity of the slurry is also measured and controlled by adjusting the slurry by deionized water, ammonium hydroxide and acetic acid. In this process, the oxide materials form a compounded material in the slurry. Then the washcoat slurry is weighted for a target amount between 80 g/L to 250 g/L of catalyst substrate volume, where a honeycomb multichannel ceramic cordierite material is used as the catalyst substrate. When the washcoat slurry is coated onto the substrate, a tooling system with vacuum is utilized and applied to ensure the washcoat slurry application at the targeted slurry loading. The washcoated substrate is carefully placed in the oven to dry at 150° C. and baked at 550° C.-750° C. for at least 4 hours.

An overcoat slurry is prepared by mixing Platinum (Pt): Palladium (Pd) salts as precursor with deionized water. The ratio between Pt:Pd ranges 1:1 to 1:39, preferably 1:19. The platinum and palladium salt solution are weighted to a targeted total metal loading of 1.1% to 14.2% in the coating. The above prepared slurry solution is then overcoated onto the washcoated substrate from the first step, by using the same tooling method with vacuum. After the overcoat process, the catalyst substrate is carefully placed in the oven and dried at 150° C. and calcined at 550° C. for at least 4 hours.

FIG. 14 illustrates a Structure 3 containing zoned washcoated substrate in accordance with some embodiments, where the front zone contains washcoated platinum solution mixed with, preferably, high surface area alumina slurry, and the rear zone is the same preparation process as making Structure 1. The front and rear zones divide the substrate volume from 1:1 to 1:9. Total precious group metal loading is 1.1%-14.2% with ratio ranging from 1:1 to 1:39, preferably 1:19.

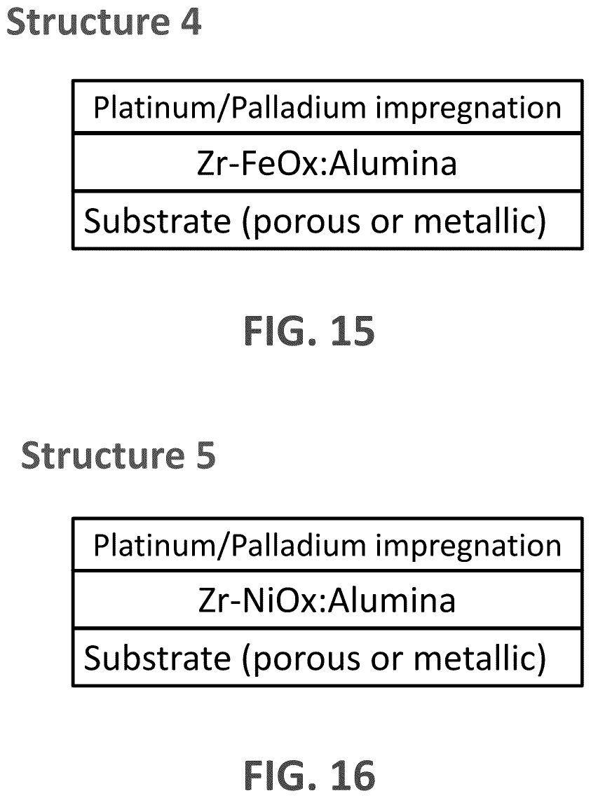

FIG. 15 illustrates a Structure 4 containing a washcoat and an overcoat in accordance with some embodiments. The washcoat contains doped Zirconia and iron oxide compounded materials, and alumina as the binder. The compositions of doped Zirconia and Iron oxide range from 1:1 to 99:1. The overcoat comprise the same as Structure 1 where Palladium is richer than platinum in the overcoat, or the mass ratio between Pt:Pd ranges between 1:1 to 1:39, preferably 1:19. Total precious group metal loading is 1.1%-14.2%.

FIG. 16 illustrates a Structure 5 containing a washcoat and an overcoat in accordance with some embodiments. The washcoat slurry is prepared according to the same procedure as Structure 1 and contains doped Zirconia and nickel oxide compounded materials with alumina as binder. The compositions of doped Zirconia and Nickel oxide range from 1:1 to 99:1. The bi-metallic platinum:palladium overcoat is the same as Structure 1. Total precious group metal loading is 1.1%-14.2% with ratio ranging from 1:1 to 1:39, preferably 1:19.

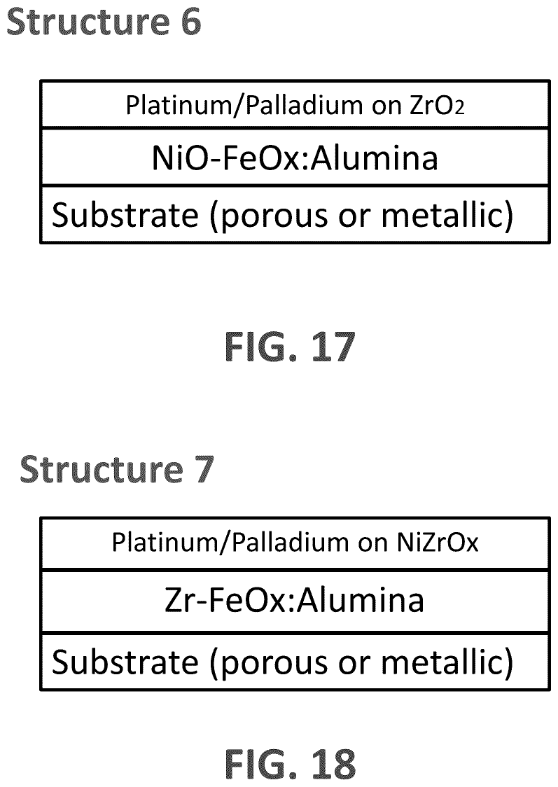

FIG. 17 illustrates a Structure 6 containing a washcoat and an overcoat in accordance with some embodiments. The washcoat contains Nickel and iron oxide compound materials with alumina binder, where the compositions of Iron oxide and Nickel oxide range from 99:1 to 99:1 by mass. The overcoat is prepared by combining the doped zirconia support particles with precious metal group metal solution and deionized water to achieve targeted total precious metal loading between 1.1%-14.2% by mass. The compositional mass ratio between Pt:Pd ranges from 1:1 to 1:39, preferably 1:19.

FIG. 18 illustrates a Structure 7 containing a washcoat as Structure 4 (FIG. 15) in accordance with some embodiments, and the overcoat with Pt:Pd metal loadings between 1.1%-14.2% where the overcoat slurry is prepare by combining the precious metal group solution with doped zirconia and nickel oxide compounded materials and deionized water, milled together and coated onto substrate. The compositions of doped Zirconia and Nickel oxide range between 1:1 to 99:1. The mass ratio between Pt:Pd ranges between 1:1 to 1:39, preferably 1:19.

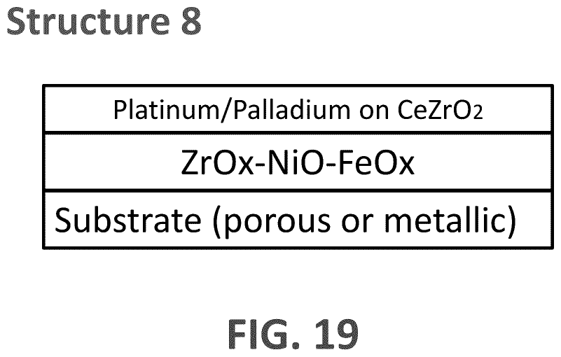

FIG. 19 illustrates a Structure 8 containing a washcoat as Structure 1 (FIG. 13) and an overcoat in accordance with some embodiments. The overcoat is coated from the slurry comprising the precious metal group precursors with Cerium-Zirconium compound oxide materials. Total precious group metal loading is 1.1%-14.2% with ratio ranging from 1:1 to 1:39, preferably 1:19.

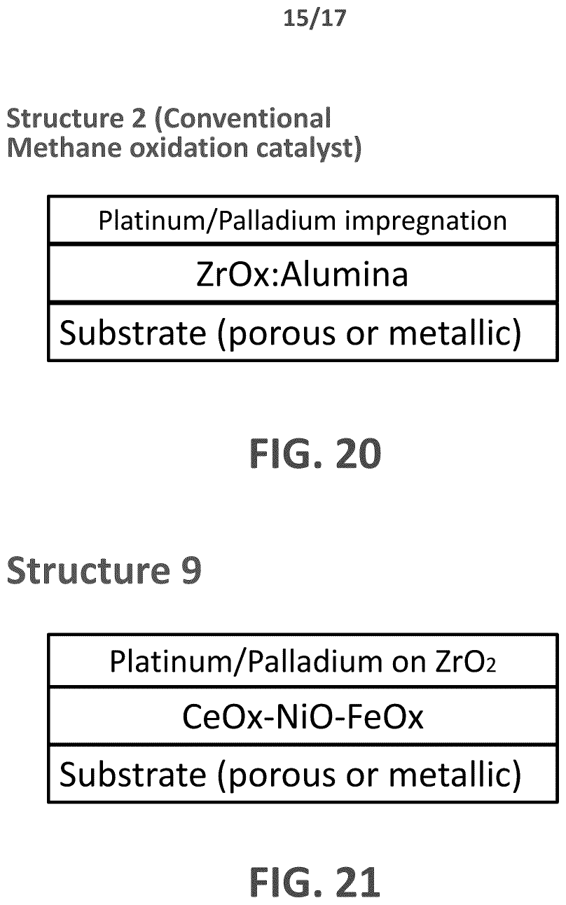

FIG. 20 illustrates a Structure 2 that is prepared by the same procedure as Structure 1 in accordance with some embodiments, where the washcoat slurry comprises 90:10 by mass of doped zirconia support particles and binder, and the same overcoat precious metal solution slurry is applied to the above washcoated substrate. Drying and calcination are applied to obtain the final product. Total precious group metal loading is 1.1%-14.2% where Pt:Pd mass ratio ranges from 1:1 to 1:39, preferably 1:19.

FIG. 21 illustrates a Structure 9 containing a washcoat and an overcoat in accordance with some embodiments. The washcoat comprises Cerium oxide, Nickel oxide and Iron oxide compounded materials where the Cerium oxide is more than 50% of catalyst material loading and the total loading of Nickel oxide and Iron oxide is less than 40%. The overcoat is the same as Structure 6 (FIG. 17).

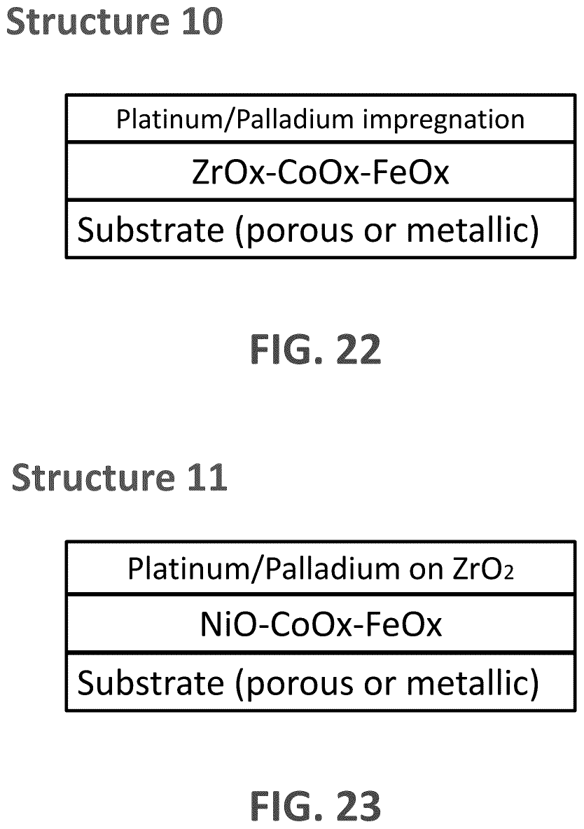

FIG. 22 illustrates a Structure 10 containing a washcoat and an overcoat in accordance with some embodiments. The washcoat comprises doped Zirconium oxide particles, cobalt oxide particles, and iron oxide particles compounded materials. The percentage of doped Zirconia composition is more than 50%, while the combined Cobalt oxide and Iron oxide % is no more than 40%. The overcoat of making is the same as Structure 1 (FIG. 13).

FIG. 23 illustrates a Structure 11 containing a washcoat and an overcoat in accordance with some embodiments. The washcoat comprises Nickel oxide, Cobalt oxide and Iron oxide compounded materials, where % of each base metal oxide loading in the washcoat materials no more than 70%. The overcoat is prepared as Structure 6 (FIG. 17).

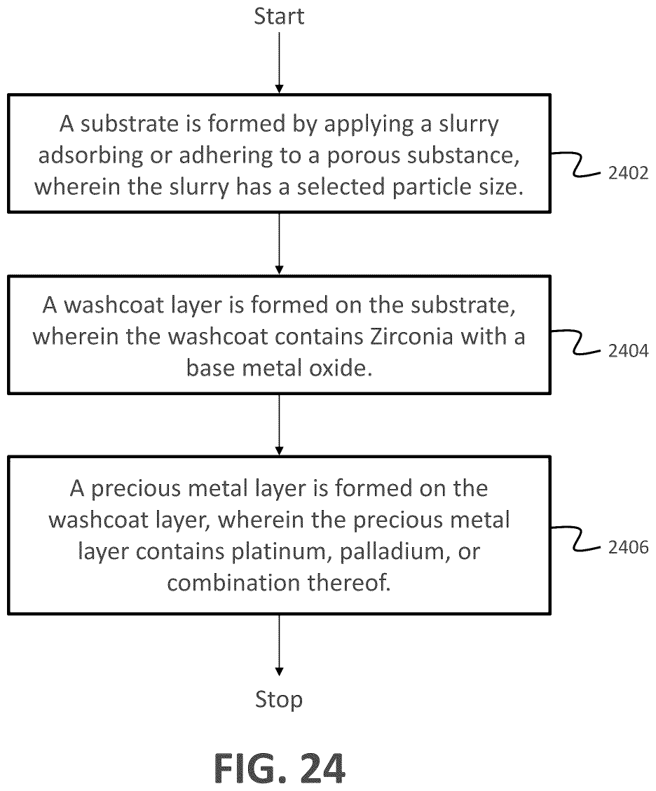

FIG. 24 illustrates a method of making a methane reactive catalyst in accordance with some embodiments. At a Step 2402, a substrate is formed by applying a slurry adsorbing or adhering to a porous substance, wherein the slurry has a selected particle size. At a Step 2404, a washcoat layer is formed on the substrate, wherein the washcoat contains Zirconia with a base metal oxide. At a Step 2406, a precious metal layer is formed on the washcoat layer, wherein the precious metal layer contains platinum, palladium, or combination thereof.

The types of catalyst substrates for this application include honeycomb ceramic substrates, metallic substrates, porous foams and monoliths, zeolite-based substrates, Silicon Carbide substrates, and low-back pressure pellet, cylinder, or beads substrates.

The dopants in the doped zirconium oxide particle include silicon, neodymium, praseodymium, yttrium, lanthanum. The doped zirconium oxide particle contains at least 95% of high temperature stabilized tetragonal structure and has surface area less than 100 m²/g measured by gas phase adsorption Brunauer-Emmett-Teller method. The total pore volume of the doped Zirconium oxide support is 0.25-0.36 cm³/g with an averaged pore size about 14-25 nanometers. When the doped zirconium oxide compounds with base metals such as pron, nickel, cobalt, the second phase of monoclinic zirconia is able to be mixed in the compounded catalyst materials.

Nickel oxides used in this disclosure include pre-formed oxides or hydroxide materials, such as NiO, Ni₂O₃, NiO₂, Ni(OH)₂ or mixtures. Nickel oxides used in this disclosure are able to be generated from Nickel precursors such as nitrate hydrated, acetate, ammonium nitrate, oxalate hydrated or mixtures.

Iron oxide used in this disclosure include pre-formed oxides or hydroxide materials, such as Fe₂O₃, Fe₃O₄, FeO, Fe(OH)₂, Fe(OH)₃, or mixtures. Iron oxide used in this disclosure is able to be generated from Iron precursors such as nitrate hydrated, acetate, ammonium nitrate, oxalate or mixtures.

Cobalt oxide used in this disclosure includes pre-formed oxides or hydroxide materials, such as CoO, Co₃O₄, CO₂O₃, Co(OH)₂, Co(OH)₃, Co(OH)₄ or mixtures. Cobalt oxide used in this disclosure is able to be generated from Cobalt precursors such as nitrate hydrated, acetate, ammonium nitrate, oxalate or mixtures.

The base-metal oxide compound materials, Ni—Fe, Ni—Co, Fe—Co, Ni—Co—Fe, used in this disclosure can be formed from nano-particle metal alloys such as NiₓFe_{y}, NiₓCo_{z}, Fe_{y}Co_{z}, NiₓFe_{y}Co_{z}, or mixtures.

The rare-earth cerium oxide particles used in this disclosure include pre-formed oxides such as CeO₂, CeO₂₋ₓ where x<1 and is the concentration of oxygen vacancies in the Ceria, Ce₂O₃, Ce (OH) 4, AlCeO₃, or mixtures. The Cerium oxide used in this disclosure is able to be generated from cerium precursors such as nitrate hydrated, ammonium nitrate, acetate hydrated, Carbonate hydrated or mixtures.

The compounded oxide materials used in this disclosure include the above materials, or mixtures within.

The above composite catalysts are examined under three conditions representing low, medium and high loads of engine exhausts: Low load: 1.25% CH₄, 1000 ppm CO, 50 ppm NO, 15% 02, 5% CO₂, 10% H₂O, balance N₂. Medium load: 2800 ppm CH₄, 400 ppm CO, 200 ppm NO, 9% 02, 5% CO₂, 10% H₂O, balance N₂. High load: 1500 ppm CH₄, 250 ppm CO, 250 ppm NO, 9% O₂, 5% CO₂, 10% H₂O, balance N₂. The air methane ratio ranges between 32:1 to 41:1. In some examples, the air-methane ratio is between 20:1 to 65:1.

The term “A/B” used in this disclosure is able to mean A or B, A and B, A alone, or B alone in different embodiments of the present disclosure. For example, Platinum/Palladium on ZrO₂ is able to refer to 1) Platinum and Palladium on ZrO₂, 2) Platinum or Palladium on ZrO₂.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. A methane abatement catalytic structure comprising:
a. a substrate, wherein the substrate is porous, metallic, or both;
b. a washcoat layer on the substrate, wherein the washcoat layer contains zirconia with a base metal oxide; and
c. a precious metal layer on the washcoat layer.

2. The methane abatement catalytic structure of claim 1, wherein the zirconia is a pure zirconium oxide.

3. The methane abatement catalytic structure of claim 1, wherein the zirconia comprises a zirconia mixture.

4. The methane abatement catalytic structure of claim 3, wherein the Zirconia mixture comprises a La-doped, Ce-doped, Pr-doped, or Nd-doped mixture.

5. The methane abatement catalytic structure of claim 1, wherein the base metal oxide comprises FeOx, NiOx, CoOx, alumina, Fe—NiOx, Fe—CoOx, Ni—CoOx, or Fe—Ni—CoOx, wherein x denotes a number of atoms.

6. The methane abatement catalytic structure of claim 5, wherein the alumina is doped.

7. The methane abatement catalytic structure of claim 5, wherein the alumina is undoped.

8. The methane abatement catalytic structure of claim 1, wherein the precious metal layer contains platinum and palladium.

9. The methane abatement catalytic structure of claim 8, wherein a ratio of platinum:palladium is 1:1 to 1:39.

10. The methane abatement catalytic structure of claim 8, wherein the ratio of platinum:palladium is 1:19.

11. The methane abatement catalytic structure of claim 8, wherein the platinum and palladium comprise palladium impregnation, platinum and palladium impregnation, platinum and palladium on ZrO₂, on NiZrOx, or on CeZrO₂.

12. A methane abatement catalytic structure comprising:
a. a substrate, wherein the substrate is porous, metallic, or both;
b. a washcoat layer on the substrate, wherein the washcoat layer contains platinum on BMOx, wherein the BMOx═FeOx, NiOx, CoOx, alumina (doped or undoped), Fe—NiOx, Fe—CoOx, Ni—CoOx, or Fe—Ni—CoOx, wherein x denotes a number of atoms; and
c. an overcoat layer on the washcoat layer.

13. The methane abatement catalytic structure of claim 12, wherein the alumina is doped.

14. The methane abatement catalytic structure of claim 12, wherein the alumina is undoped.

15. The methane abatement catalytic structure of claim 12, wherein the overcoat layer comprises Pt/Pd in an oxide form adsorbed on OSM (oxygen storage materials).

16. The methane abatement catalytic structure of claim 12, wherein the oxide form comprises a supporting oxide having porous zirconia.

17. The methane abatement catalytic structure of claim 16, wherein the porous zirconia is undoped.

18. The methane abatement catalytic structure of claim 16, wherein the porous zirconia is Ce-doped, Pr-doped, or Nd-doped.

19. The methane abatement catalytic structure of claim 16, wherein the porous zirconia further comprises ceria, doped alumina, or undoped alumina, or a combination thereof.

20. The methane abatement catalytic structure of claim 15, wherein a ratio of Pt/Pd is 1:1 to 1:39.

21. The methane abatement catalytic structure of claim 15, wherein a ratio of Pt/Pd is 1:19.

22. A method of making a methane reactive catalyst comprising:
a. forming a substrate by applying a slurry adsorbing or adhering to a porous substance, wherein the slurry has a selected d50 particle size between 2.5-7.5 μm;
b. forming a washcoat layer on the substrate, wherein the washcoat contains Zirconia with a base metal oxide; and
c. forming a precious metal layer on the washcoat layer, wherein the precious metal layer contains platinum, palladium, or combination thereof.

23. The method of claim 22, wherein the Zirconia comprises a mixture of a La-doped, Ce-doped, Pr-doped, or Nd-doped mixture.

24. The method of claim 22, wherein the base metal oxide comprises FeOx, NiOx, CoOx, alumina, Fe—NiOx, Fe—CoOx, Ni—CoOx, or Fe—Ni—CoOx, wherein x denotes a number of atoms.

25. The method of claim 22, further comprising heating and drying a catalyst-coated monolith substrate in an oven at least 150° C. for at least 2 hours.

26. The method of claim 25, further comprising ramping a temperature of 3° C./min rate to a higher temperature at least at 550° C. but below 800° C. in air, for at least 4 hours.

27. The method of claim 22, wherein the zirconia comprises a tetragonal phase, a monoclinic phase, or a combination thereof.

28. The method of claim 27, wherein the tetragonal phase is generated by using a high temperature above 900-2500° C.

29. The method of claim 27, wherein the tetragonal phase is generated by using a pressure-driven phase transition above 5-35 GPa at a rather lower temperature 650° C. and below 2000° C.

30. The method of claim 22, wherein the zirconia comprises a zirconia support having at least 80% of the tetragonal phase with less than 10% of rare-earth dopants.

31. The method of claim 30, wherein the rare-earth dopants comprise Lanthanum (La), Cerium (Ce), Praseodymium (Pr), or Neodymium (Nd).
